(19) United States
(12) Patent Application Publication
(10) Pub. No.: US 2013/0199463 A1
(43) Pub. Date: Aug. 8, 2013

(54) MACHINE

(71) Applicants: Martin Pischinger, Munich (DE); Christoph Steffens, Kerpen (DE); Karsten Wittek, Aachen (DE); Markus Kalenborn, Dornstadt (DE)

(72) Inventors: Martin Pischinger, Munich (DE); Christoph Steffens, Kerpen (DE); Karsten Wittek, Aachen (DE); Markus Kalenborn, Dornstadt (DE)

(73) Assignee: FEV GMBH, Aachen (DE)

(21) Appl. No.: 13/704,847

(22) PCT Filed: Jun. 24, 2011
(86) PCT No.: PCT/EP2011/003113

§ 371 Date: Dec. 17, 2012

(30) Foreign Application Priority Data
Jun. 24, 2010 (DE) 10 2010 025 002.3

(51) Int. Cl. F02B 65/00

(52) U.S. Cl. CPC F02B 65/00
USPC 123/2

(57) ABSTRACT

The present invention relates to an energy-conversion system comprising an internal combustion engine (1) and a generator (2) which is driven by the internal combustion engine, and comprising a rotational connection which couples a first shaft (3) of the internal combustion engine (1) to at least one second shaft (5) of the energy-conversion system, wherein the second shaft (5) rotates in the opposite direction to the first shaft (3) and the first shaft (3) is arranged parallel to the second shaft (5), wherein products of moments of inertia and respectively associated rotational speed ratios of individual rotating components, which are rotationally coupled to one another by means of the rotational connection, at least approximately cancel one another out.

### CROSS REFERENCE TO RELATED APPLICATIONS

This application is a continuation of PCT/EP2011/003113 filed Jun. 24, 2011, which claims priority of German Patent Application 10 2010 025.002.3 filed Jun. 24, 2010.

### FIELD OF THE INVENTION

The present invention relates to an energy conversion system, preferably an internal combustion engine, with a shaft rotating in the opposite direction from that of the crankshaft.

### BACKGROUND OF THE INVENTION

Using balance weights, for example, for compensating imbalances in the area of the crank drive in driven machines, is known from the prior art. Said weights are arranged in such a manner that first and second order forces can be compensated. For instance, a mass compensation for a reciprocating-piston internal combustion engine is known from DE 40 24 400 A1. Specifically, this relates to an internal combustion engine with three rows of four cylinders, connected via a common crankshaft. This publication shows that two compensation shafts bearing balancing weights and seated on the internal combustion engine that are driven at twice the speed of the crankshaft are to be provided in order to compensate for mass forces and torques, especially those of second order. The equations for the torque analyses and the analysis of forces can be found in the publication itself. It is also seen there that mass forces rotating in opposite directions at the given speed form circulating vectors that are minor-symmetric with respect to the shaft and are intended to cancel one another out. From this it can be concluded that two balance shafts that are capable of compensating resulting torques should be arranged. The balance shafts themselves are arranged in the crankcase. Appropriate bearing points for the balance shafts are created by crankcase tunnels with corresponding openings. DE 2904066 describes an internal combustion machine in which the balance shaft is driven with the identical speed but in the opposite rotational direction. This publication also discusses a number of different internal combustion machines and explores how torques can cancel out one another. Here too, the prior art refers to an article in the journal ATZ from 1978, no. 1, p. 32, in which the fundamental possibility of compensating mass by an opposite rotational direction of a balance shaft was pointed out.

Balance shafts are therefore designed, as the above-cited examples of prior art show, to compensate for an imbalance behavior of the machine.

DE 37 20 559 C2 also discloses an internal combustion machine with which alternating torques produced by gas forces or mass forces are to be compensated. The design in this case provides that a compensation mass rotationally driven in the opposite direction to the crankshaft should be designed so that its moment of inertia substantially corresponds to the moment of inertia of the flywheel masses arranged on the crankshaft multiplied by the reciprocal value of the transmission ratio between the compensation mass and the crankshaft. DE 41 19 065 A1 discloses a design in which the moment of inertia of a balance shaft is to be roughly half as large as a moment of inertia of a flywheel mass on the crankshaft. DE 199 28 969 A1 discloses a design for how longitudinal moments should be compensated, taking into account inertial forces of a balance shaft and a connection to a crankshaft. A weight of the balance shaft is to be reduced by the dimensioning of the distances.

### SUMMARY OF THE INVENTION

The problem of the present invention is to create an energy conversion system that has low susceptibility to vibration and is versatile.

An energy conversion system with the characteristic features of Claim 1 is proposed. Advantageous features, configurations and refinements follow from the description below as well as from the claims, wherein individual features from a configuration are not restricted thereto. Instead, one or more features from one configuration can be linked to one or more features of another configuration to form additional configurations. The formulation of Claim 1 in the form of the application also serves only as a first draft formulation of the subject matter to be claimed. One or more features of the formulation can therefore be replaced and even omitted, and additional ones can likewise be added. The features cited based on a special embodiment can also be generalized or can be used in other embodiments, particularly in applications.

It is proposed to create an energy conversion system having an internal combustion machine and a generator driven by the internal combustion machine and with a rotational connection that couples a first shaft of the internal combustion machine to at least one second shaft of the energy conversion system, wherein the second shaft rotates in the opposite direction to that of the first shaft and the first shaft is arranged parallel to the second shaft, wherein products of moments of inertia and respective associated rotational speed ratios of individual rotating components rotationally coupled to one another by means of the rotational connection at least substantially cancel one another out. A sum of products of respective signed transmission ratios and moments of inertia is preferably approximately zero.

This compensation is preferably relative to the first shaft as the reference point, in particular to a plane perpendicular to an axis through the first shaft.

According to one configuration, it is provided that the rotational connection be absolutely free of play, at least in operation. It is preferably provided that the rotational connection is designed to be free of play even while stationary. For example, there can be a tension present that guarantees mutual contact of force-transmitting surfaces at every point in time.

A compensation with the sum of the products of the rotational speed ratios and the respective moments of inertia going to zero has the effect that the energy conversion system in its basic structure can be more easily constructed, according to one configuration. The loads advantageously cancel one another out. Thereby the forces to be absorbed in the basic structure with respect to the bearing, for example, are lower. The design for mounting the energy conversion system can also have a lower strength, according to one refinement, and thus enables a lower weight.

According one configuration, the energy conversion system comprises a generator. The energy conversion system itself can also be a generator. It is preferred that the energy conversion system comprises an internal combustion machine, or is an internal combustion machine, for example. Another configuration provides that the energy conversion system comprises at least one internal combustion machine and a generator. These are preferably arranged in a common housing structure. For example, respective individual housings of individual components such as an internal combustion engine and a generator may be connected to one another, but are at least coupled to one another so as to transmit force and therefore compensate torque.

Various refinements will be presented below, based on a configuration of the energy conversion system as an internal combustion machine. These refinements are not limited to this special configuration, but are instead to be understood as examples. Thus the features presented in connection with the internal combustion machine can also be linked to other energy conversion systems such as a generator, a pump, a condenser, a turbine or any other energy conversion system subjected to inertial forces. The concept can be used for stationary and mobile applications such as combined heat and power plants, electric generators, vehicles of all types, ships, aircraft, motorcycles, and for mobile handheld implements such as chainsaws and the like. For example an APU, short for “auxiliary power unit,” of a vehicle or an armored vehicle can comprise the proposed energy conversion system. The second shaft can also be an input shaft of a component from the group comprising a mechanical loader, an air-conditioner compressor, a vacuum pump, a power steering pump and a coolant pump.

It is further provided that the compensation of the products of moments of inertia and rotational speed ratios relates in particular to a machine frame such as an engine block, in which or on which the at least one second shaft, more particularly as a balance shaft unit, is arranged. Preferably, a compensation that does not include only one shaft of the energy conversion systems and one balance shaft is carried out. For example, the machine frame is considered as a whole. If an engine block is used, for example, all units that are arranged on the crankcase are considered in relation to their respective inertial forces and torques and to the associated rotational speeds or rotational speed ratios. These units can include, for example, the drives of pumps or other attached components, balance weights and/or other things. These may also include components that are arranged on a cylinder head, such as a valve train. Thus all rotating masses and their moments of inertia along with the associated rotational speed ratios are preferably covered in the compensation, in particular, in such a manner that in the engine itself with a flanged generator, for example, the sum of the products of moments of inertia and rotational speed ratios is approximately compensated and therefore approaches zero, preferably is zero, in relation to a balance limit.

A bearing for the additional shaft is preferably arranged in the machine frame. The bearing can also be present in the cylinder head or the engine block.

A preferred configuration comprises an internal combustion machine, having an engine housing, with a valve train and a cylinder head, a crankshaft in a crankcase as the first shaft, and a balance shaft unit with at least one balance shaft as the second shaft, wherein a sum of the products of moments of inertia and the respective associated rotation speed ratios of individual components coupled to one another, comprising at least the crankshaft and the balance shaft on the motor housing of the internal combustion engine, is at least approximately compensated.

According to one configuration, the cylinder head can comprise one or more camshafts. There is also the possibility that the camshaft may be arranged outside the cylinder head. Thus, for example, a camshaft arranged at the bottom or the side can be provided. A valve train adapted thereto may be present. A valve train not driven by a camshaft can also be used.

Compensation is to be understood here to mean that, preferably with relation to a balance limit, the products of the moments of inertia and associated rotational speed ratios equalize one another to such an extent that no or at least approximately no roll moment is present in relation to this balance limit.

According to one configuration, it is provided that an internal combustion machine comprises a balance shaft that drives a driven machine such as a generator. A pump can also be driven. According to one configuration, the driven machine is directly coupled to the balance shaft. For example, the generator can comprise a rotor that is simultaneously part of the balance shaft.

The internal combustion machine can be a one-cylinder, a two-cylinder or a three-cylinder machine. Four or more cylinders can also be provided. In addition to an in-line arrangement of the cylinders, a V or W arrangement can also be used.

The internal combustion machine is preferably arranged in a hybrid vehicle. For example, the internal combustion machine can provide a main driving force of the hybrid drive. There is also the possibility that the internal combustion machine is arranged in a vehicle as a range extender.

In response to high requirements for fuel savings, engines with low numbers of cylinders, low rotational speeds and turbocharging are preferred. Due to their pronounced nonuniformity of rotation, however, these engines are problematic with respect to their NVH (noise vibration and harshness—abbreviated NVH) behavior. Especially for a range extender, an internal combustion engine with very good NVH behavior is required, which can be switched on, switched off and operated inconspicuously. By compensating the effective torques on the range extender, it is possible to achieve this as desired.

It is further preferred that the internal combustion machine comprise a rotational connection, which comprises a planetary gear unit, for example. By means of the planetary gear unit, for example, a balance mass can be implemented thereon which enters into the calculation of the moments of inertia. The same applies to an adjustment of the transmission ratio. Thus a part of a compensation of the product of rotational speed and inertial force for the crankshaft can be accomplished by the balance shaft and the planetary gear unit. There is preferably a larger compensation of the moment of inertia by the balance shaft than by the planetary gear unit.

Another configuration provides that the internal combustion machine is operated according to the Atkinson principal in order to minimize exhaust pressure surges.

Another configuration provides that the internal combustion machine is turbocharged and operates according to the Miller process. There also exists the possibility that, depending on the operating range, the internal combustion machine is operated in a different manner corresponding to a process, for example, according to the Otto, the diesel, the Atkinson, the Miller, and/or another process.

Another configuration provides that the internal combustion machine has the balance shaft simultaneously functioning as a camshaft.

It is preferred that the rotational connection comprise a backlash-free gear connection.

The balance shaft is preferably designed to take account of the first and second order forces and compensation thereof by appropriate counterweights. But the moment of inertia of the balance shaft is also selected in such a manner that, relative to the reference system, the sum of the active moments of inertia at least approaches zero, if it does not become zero.

In an internal combustion engine, the energy is largely transferred to a flywheel in the combustion stroke. The flywheel is accelerated thereby and stores the energy in the form of kinetic energy. In the remaining cycle segments, the energy is taken from the flywheel, whereby a nonuniform rotational speed progression results due to the acceleration of the masses and the gas forces. The rotational acceleration results in an opposing acceleration of the engine housing, which must be absorbed by the motor mounts. This applies to all internal combustion engines. For passenger car engines, there is also the torque of the output shaft on the motor mount, but this has a much more quiet progression. For a range extender, the output to the generator is integrated into the overall system. Therefore there are no external torques. The dynamic torques in the suspension of the range extender are nearly eliminated by the present proposal.

The invention will be further described below using the example of a range extender, individual configurations and features not being limited to this application, but rather also usable in additional applications:

An additional shaft running in the opposite direction of the crankshaft is mechanically connected as stiffly as possible to the crankshaft. This can be solved, for example, by mounting a sprocket wheel, on which a gear connected to the additional shaft runs, on the crankshaft. The rotational directions of the crankshaft and the additional shaft are opposite due to the described arrangement. The bearing for the additional shaft is integrated into the engine block. A different rotational connection can be used, however. For the range extender, but also for other applications, the additional shaft is used as a generator shaft, for example. The transmission ratio (i) is selected so that at low engine speeds (e.g. <1500 rpm), the optimum generator rotational speed (e.g. 4500 rpm; i=−3) is achieved.

ω_{Generator}=i*ω_{crankshaft}

The effects of the rotational nonuniformity are eliminated if the moment of inertia J of the crankshaft is greater by the factor lil than the moment of inertia of the generator shaft.

J_{crankshaft}=i*J_{Generator}

Due to this design, the overall moment of momentum in the range extender is equal to 0 at every rotational speed and also remains equal to 0 for every change of rotational speed. Thus no forces or torques are transmitted to the exterior, even in case of changes of rotational speed.

0=ω_{crankshaft}*J_{crankshaft}+ω_{Generator}*J_{Generator}(total moment of momentum=0)

The sum of all external torques about the crankshaft axis=0:

0=\acute{ω}_{crankshaft}*J_{crankshaft}+\acute{ω}_{Generator}*J_{Generator}

The rotational acceleration of the connecting rod is not taken into account here. The torques occurring thereby only play a subordinate role, particularly at low rotational speeds. If additional parts with different transmission ratios, such as the camshaft, alternator or planetary gears of the planetary gear unit, are connected to the crankshaft or the oppositely rotating shaft, then the moments of inertia of these parts must be multiplied by the transmission ratio of the shaft rotating in the same direction and then added to the moment of inertia of the shaft rotating in the same direction. If one defines the transmission ratio i as a signed magnitude, the system is properly designed if the sum of the products of the respective transmission ratios and moments of inertia is equal to 0.

$$0 = {\sum }_{k = 1}^{k = n} {i}_{k} * {J}_{k}$$

Due to the appropriately designed oppositely rotating shaft, the firing interval no longer plays a dominant role with respect to NVH. This results in the possibility of operating small numbers of cylinders, such as one, two or three cylinders, at low rotational speed, for example <1000 rpm, whereby the influence of the free mass forces becomes small. This also has great advantages with respect to costs and efficiency. Turbocharging of the internal combustion engine is facilitated.

The influence of the rotational acceleration of the connecting rod can be nearly compensated by a 2-cylinder in-line engine. The torque about the crankshaft axis then becomes nearly 0 for the range extender.

The following configurations can also be provided:

In order to achieve a favorable package behavior, the generator is arranged alongside or above the crankcase.

The additional shaft can be connected via a planetary gear unit to the crankshaft. For example the following connections are possible: The crankshaft—eccentric shaft for a Wankel engine—is fixedly connected to the ring gear. The ring gear is designed such that the moment of inertia of all parts turning in the rotational direction of the eccentric shaft has the appropriate magnitude according to the invention. The carrier of the planetary gears is fixedly connected to the engine housing, thus preferably to the range extender housing, and transfers the compensation torque. The sun wheel is connected to the output shaft and thus rotates in the opposite direction from the crankshaft. The appropriate moment of inertia must be present here. For the range extender, the output shaft is fixedly connected to the generator shaft and the moment of inertia corresponds to the moment of inertia of the generator.

The additional shaft can also be driven on the free crankshaft side.

The additional shaft can be driven by a belt. An externally and internally profiled, preferably toothed, belt is especially preferred.

According to one configuration, it is provided that the rotational connection comprises a belt drive. It is provided, for example, that there is a connection to the balance shaft by means of a first and a second belt that are wrapped in opposite directions. The first and the second belt are therefore able to equalize the force transmission in both rotational directions, for example. Thus the traction force can be immediately transmitted in each rotational direction. In case of accelerations of the crankshaft, the balance shaft can thus likewise be immediately accelerated, independently of the rotational direction and without taking into account any otherwise present micro-delay before the force transmission becomes active. In order for belt wrapping to become possible, another load to be driven by the crankshaft can also be included in the rotational connection. A refinement provides that one or more loads, which are preferably directly driven by the crankshaft or the balance shaft, are coupled by means of a belt drive. If a belt drive is used, a large portion of a moment of inertia that runs, in particular, in the same direction as the crankshaft of the internal combustion machine can likewise be driven by the belt. This can at least partially compensate for a possible elasticity of the belt drive by achieving a similar delay behavior of the angular acceleration in both rotational directions due to the elastic force transmission.

Alternatively and also additionally, a rotational connection can also provide a chain drive.

In order to minimize the exhaust pressure surge, the Atkinson process is selected, and the Miller cycle is selected for turbocharged engines.

For a transmission ratio of 1/2, the additional shaft can be used as a camshaft.

The invention applies to all internal combustion engines, thus also to Wankel engines and 3-cylinder engines, for example.

The engine can be turbocharged.

The additional shaft can be retrofitted as an add-on package on existing engines.

In order to prevent the occurrence of a contact alteration for every occurrence of play during operation, it makes sense to perform output driving by the oppositely rotating gearwheel. If the output torque is greater than the minimum torque of the crankshaft, no contact alteration occurs. This can be achieved for a range extender in particular. Freewheeling operation is not required.

To allow a favorable contact alteration of the gearwheels, a divided gearwheel can be operated with an initial tension.

An influence of a rotational acceleration of the connecting rod can be nearly compensated by a 2-cylinder in-line engine according to the described technical teaching.

The roll moment about the crankshaft for the range extender goes essentially to 0 when starting and stopping, because the free mass forces in the low-speed range become negligibly small. This means that switching the range extender on and off is not noticed by the vehicle user.

A preferred field of use for the proposed range extender is to support the driving of an electric motor or the charging of a battery for an electric motor. In addition, an electric motor connected to the range extender can be directly driven via a generator. There is also the possibility of charging a battery, with which the electric motor is driven, by means of the generator. There further exists the possibility of using the range extender alternately: if insufficient battery voltage is present, the battery is charged, and if the electric motor requires additional torque in a given driving range such as when accelerating, the generator to which the range extender is coupled can produce the required power.

An energy conversion system is additionally proposed in which the first shaft is arranged vertically in such a manner that an axis of the first shaft runs parallel to an earth acceleration vector.

Another configuration can provide, for example, that the associated speed ratio of the rotational connection is adjustable, preferably variably adjustable. For instance, a transmission ratio for a spur gear unit or a bevel gear drive can be varied. This makes sense, for example, if one or more auxiliary units that are connected as components to the energy conversion system are switched on or off. This is provided for a compressor that can be switched on as a component, for example. If the compressor is not required, it is switched off, whereupon a transmission ratio of the rotational connection in the energy conversion system can be varied to adapt thereto. For this purpose, a clutch system can be used, by means of which a rotational connection allows a changing rotational speed ratio or a varying transmission ratio, for example. If a manual transmission is provided as the component, for example, a speed ratio adapted to the gear stages can be provided. A variation can be fixedly specified, for example, a change from a first value to a fixed second value distinct therefrom. There is also the possibility that a change can be variable along a range, particularly that each value inside the range can be assumed.

It is preferred that the energy transmission system have a transmission ratio between the first and the second shaft set to a non-integer value. A refinement provides that a transmission ratio between the first and the second shaft is adaptable. Thus it is possible for a tension adjustment to be made for a belt drive, by means of a tensioning roller, for example. But there is also the possibility that a spatially different arrangement results due to the relative motion between the tensioning roller and the first and second shafts, and there is a concomitant change of the transmission ratio. A pivoting mechanism that effects a tracking of at least one of the three elements, while the transmission ratio is simultaneously changed, can be provided for this purpose. Thus the rotational connection can be implemented as a transmission, for example, preferably a continuously variable transmission. A planetary gear unit can alternatively or additionally be used as well. It is possible to use a variator that comprises, for example, two axially movable pairs of conical pulleys and a traction means, particularly a V-belt, running between them. By means of the variator, it is possible to assume specifiable transmission ratios, and in case of small deviations with respect to the desired cancellation of the products of moments of inertia and transmission ratios, there can be a further adjustment, in particular a fine adjustment. This can be accomplished on a controlled or regulated basis, and by means of a self-learning system.

Another configuration provides that a step-up ratio of i=2 is set for a rotational connection of the crankshaft to a roll moment compensation shaft. Then the roll moment compensation shaft can be provided with a balance weight that is adjusted to reduce an amplitude of a second order mass force. More particularly, there is a possibility of a reduction by 50%. This refinement can be used, for example, for a one-cylinder engine, for an in-line engine with two cylinders in which the offsets for the connecting rods are rotated by 180° (R2 180°), for an in-line engine with two cylinders in which the offsets are not rotated relative to one another (R2 360° or R2 0°), i.e. a parallel twin, and for a V-engine with two cylinders in which the crankshaft has an offset for the connecting rods of 90° (V2 90°). Other constellations are also possible, e.g. more than two cylinders. If a complete compensation of the second order mass force is to be created, an additional roll moment compensation shaft that is furnished with an adjusted flywheel is used. The principle of also compensating the second order mass forces at least approximately, in addition to compensating the products of the moments of inertia and the transmission ratios, can also be implemented in other constellations of the engine structure, number of cylinders, number of roll moment compensation shafts, length of the cranks, etc.

### BRIEF DESCRIPTION OF THE DRAWINGS

Additional advantageous configurations and features follow from the drawings below. The individual features found in the figures are only for the sake of example and are not limited to the respective configuration. Instead, one or more features from one or more figures can be combined with one or more features of the remaining description into further configurations. Therefore the features are not provided for limitation, but rather for the sake of example. Therein:

FIG. 1 shows a first schematic example configuration,

FIG. 2 shows a possible use of a planetary gear unit,

FIG. 3 shows a schematic representation of the active forces,

FIG. 4 shows an example configuration of a rotational connection by means of a belt drive,

FIG. 5 shows a first view of an energy conversion system as an example,

FIG. 6 shows another view based on that from FIG. 5

FIG. 7 shows a cross-sectional view with relation to the energy conversion system from FIG. 6,

FIG. 8 shows another view of the energy conversion system from FIG. 5,

FIG. 9 shows a view along a section plane from FIG. 8,

FIG. 10 shows an example arrangement of an energy conversion system in a vehicle,

FIG. 11 shows a first exploded view of the energy conversion system from FIG. 10, and

FIG. 12 shows a second exploded view of the energy conversion system from FIG. 10. [sic; FIGS. 13 and 14 are not described here.]

### DETAILED DESCRIPTION OF THE PREFERRED EMBODIMENTS

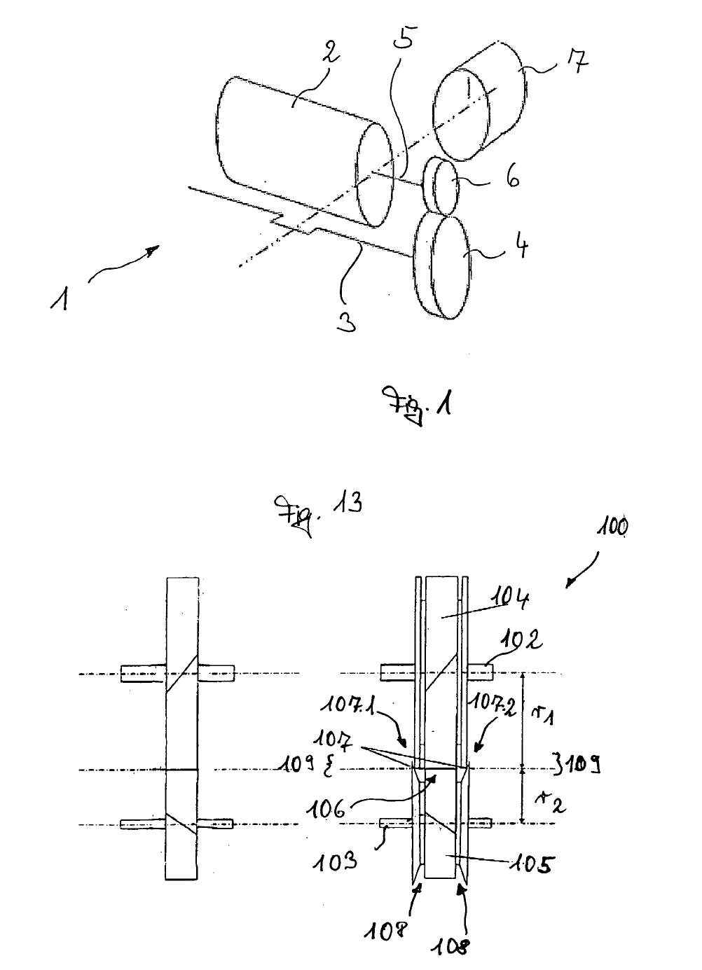

FIG. 1 shows an example configuration of a one-cylinder internal combustion engine 1 with a serially arranged generator 2. A flywheel 4, via which the generator 2 is driven, is arranged on a crankshaft 3. The flywheel 4 here has teeth which engage in the teeth of a compensation weight 6 belonging to a balance shaft 5. The balance shaft 5 is simultaneously in part a rotor of the generator 2. The generator 2 is arranged parallel to the crankshaft 3. The piston 7 of the one-cylinder internal combustion engine 1 thus moves vertically with respect to the balance shaft 5.

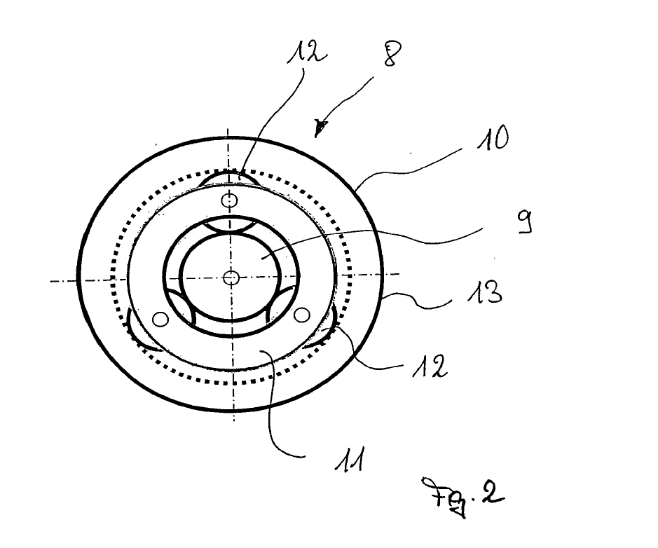

FIG. 2 shows a planetary gear unit 8 that can be used for a configuration according to FIG. 1, for example. A sun wheel 9 is coupled to a generator 10, for example. For this purpose, the sun wheel may be directly coupled to the generator shaft. A planet carrier 11 is mounted on the housing of the internal combustion machine and is rigid. One layer of planetary gears 12 is shown, but two or more layers of planetary gears and therefore a different transmission ratio and different rotational speeds can also be provided. The ring gear 13 is in turn coupled to the crankshaft.

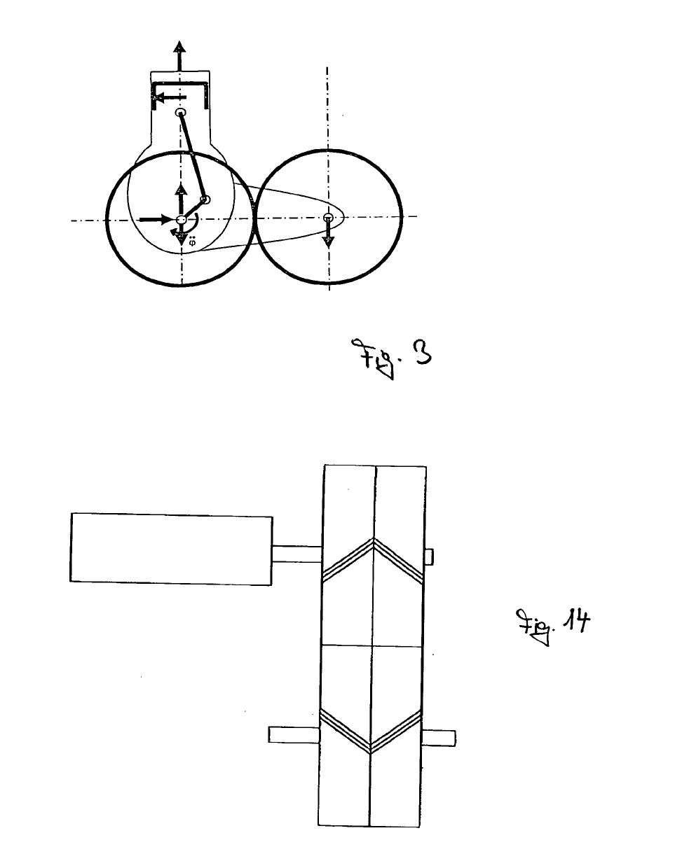

FIG. 3 shows a schematic view of active forces and the compensation thereof, particularly the compensation of a resulting moment of inertia.

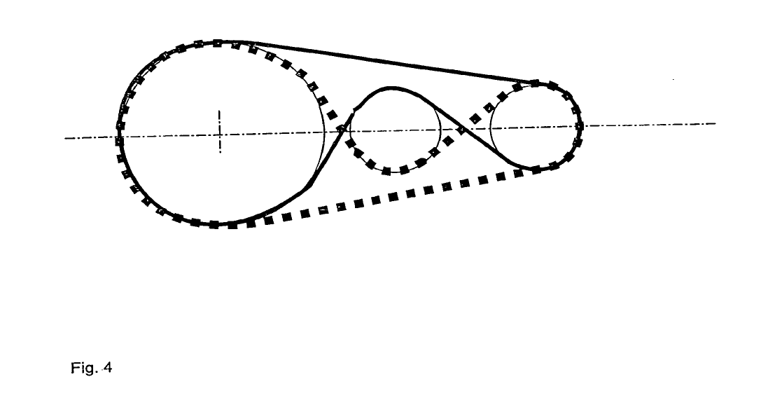

FIG. 4 shows an example configuration of a rotational connection. The crankshaft, indicated by the largest diameter, is connected here to an oppositely rotating balance shaft via a first belt marked as a solid line and a second belt marked by a broken line. If the rotational direction of the crankshaft is changed, the transmission of forces thereby acts immediately on the balance shaft, nearly independently of the direction of rotation. In order to make wrapping of the belts possible, particularly under this consideration of immediate traction force action, a load driven by the crankshaft such as a pump or the like is arranged in such a manner that it rotates identically to the crankshaft and in the opposite direction of the balance shaft. This allows wrapping by the belts as shown. In different constellations, an identically functioning wrapping can also be achieved with two belts. Acceleration jolts and imbalances due to nonuniform simultaneous acceleration can be avoided by the immediate simultaneous acceleration of the moments of inertia coupled by means of the rotational connection. Due to the total moment of inertia adjusted to go to zero relative to the balance limit even while accelerating or decelerating, starting or braking of the range extender is not perceptible to the vehicle user. Jolts that would otherwise be noticeable are avoided.

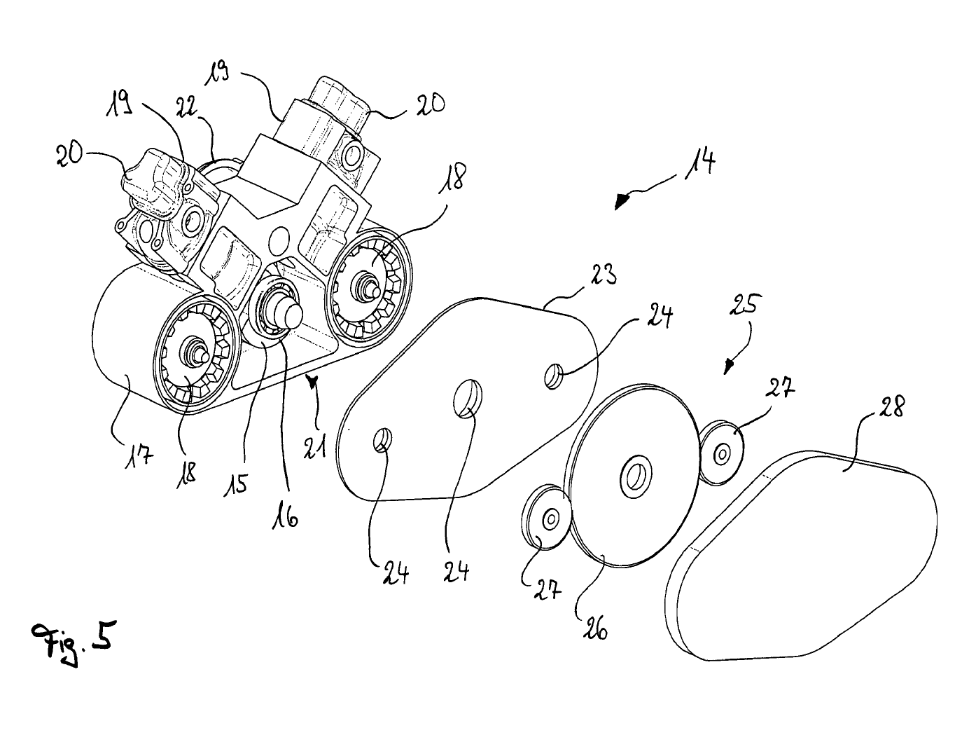

FIG. 5 shows the energy conversion system 14 in an exploded view. The energy conversion system 14 comprises a centrally arranged crankshaft 15. The crankshaft in this configuration is supported with rolling contact and has a rolling-contact bearing 16. In the structure of the energy conversion system 14 shown here for the sake of example, a crankcase 17 does not comprise merely the crankshaft 15 and the rolling bearing 16. Instead, at least one, and in this case two, rotors 18 are arranged in the crankcase 17. The axes of the two rotors 18 can lie in a plane with the axis of the crankshaft 15. According to another configuration, the axes of the rotors 18 are underneath the axis of the crankshaft 15. A V-engine is additionally provided in the energy conversion system 14 presented here. This case involves a two-cylinder V-engine. The V-engine preferably has a 90° angle. This succeeds in eliminating first order mass forces, for example. The cylinder capacity for the proposed energy conversion system 14 is preferably between 0.5 and 1.2 L. This does not apply only to the V2 engine presented here. Such a cylinder capacity is also sought for one-cylinder, two-cylinder or three-cylinder engines, even of other designs. The crankcase 17 is preferably integrally formed as a cast part. In addition to using cast iron, a magnesium light alloy can also be used. Cast aluminum can also be used. The two cylinder heads 19 can be made of the same material as the crankcase 17, or of a different material. Three or four valves are preferably arranged in the cylinder head 19. According to one configuration, however, it is possible to provide only an intake and an exhaust valve.

A design implementation as proposed here provides, for example, that the cylinder heads 19 and any possible cylinder caps 20 do not project laterally past the crankcase 17. Instead, a width of the energy conversion system 14 is thus determined by the width of the crankcase 17. The crankcase 17 preferably has at least a flat bottom 21. The crankcase can also have two flat sides, especially if the engine can be arranged both horizontally and vertically in operation. An energy conversion system 14 can be mounted on the flat side, for example. This allows the use of the energy conversion system 14 as a portable unit, for example.

The arrangement of the generators proposed here, a respective generator being arranged on each outer side next to the cylinders, enables a particularly compact overall shape, in which in particular, the length of the engine can remain unchanged. A dead space that results due to the V-design can be used by the generators. There is a further possibility of providing a valve train with a lower camshaft. There is also a possibility of placing an airbox, which distributes the supply air to the cylinders, in the V-geometry of the engine. It is also possible for a timing assembly, which allows a connection between the crankshaft 15 and the camshaft or camshafts, to be arranged at one end of the energy conversion system 14. A crankcase cover 22 that conceals the timing mechanism is shown as an example. A gear train 25 as shown in the exploded view of FIG. 5 can then be arranged at the opposite end. For example, an intermediate plate 23 that is placed on the crankcase 17 is arranged on the opposite side of the gear train 25. Bearing receptacles 24 are preferably arranged in the intermediate plate 23 and accommodate the rolling-contact bearing 16 for the crankshaft 15 as well as the bearings, preferably likewise rolling-contact bearings, of the two rotors 18 for the generators arranged in the energy conversion system 14. The gear train 25 can then be placed on the crankshaft 15 and the rotor shafts.

In this configuration, the gear train has a first gear 26 seated on the crankshaft 15 and a respective second gear 27 on each rotor shaft. A direct placement on the respective shaft is preferred, because play such as can otherwise occur if additional components are inserted is thereby avoided. The first gear is preferably larger than the second gear. It is especially preferred if the transmission ratio is in a range between i=2 and i=5, especially preferably i=3 or approximately 3. A generator rotational speed of up to 20,000 rpm is especially preferred. A casing cover 28 can in turn be placed on the gear train 25. In addition to concealing it and therefore the achievement of a protective function for the gear train 25, the placement of the casing cover 28 as well as the casing cover 22 additionally offers the possibility of a damping, especially sound damping. In this manner an especially quiet operation is possible for the proposed V-motor with integrated generators, in addition to a roll moment compensation. This also has an effect during starting and stopping of the engine, because in addition to an avoidance of vibrations, noises that are generated can be adjusted by appropriate damping devices such as damping mats or the like to the frequency range to be damped.

FIG. 6 shows an example configuration of a dimensioning of an energy conversion system based on the energy conversion system 14 with two generators, as seen in FIG. 5. Two systems of V-motors are shown schematically in FIG. 6: First, one with two generators, indicated by the outermost frame labeled with the reference number 29, and second, one with one generator, emphasized by the outer frame with the reference number 30. If one generator is arranged, it is preferably arranged in the V-shaped area formed between the two cylinders. This can result in a greater height of the energy conversion system 14. As indicated, the schematically shown generator 31 defines the upper final dimension. If two generators are used, which are arranged as legs of the crankcase in the energy conversion system 14, then the upper final dimension results from the cylinder caps 20 as an extension of the cylinder heads 19 with integrated camshafts 32. A final lower dimension is determined, for example, by a base frame 33 on which the energy conversion system 14 can be arranged. Depending on the geometry of the crankcase 17, however, a different lower dimension and lateral dimension can be made available. As shown, an approximately square outer frame 30 can be achieved if a single generator 31 is arranged. If two generators are used, on the other hand, compactness of the energy conversion system 14 is achieved by virtue of the fact that a height H_{Basis} is lower than a width, due to the arrangement of the two rotors of the respective generators.

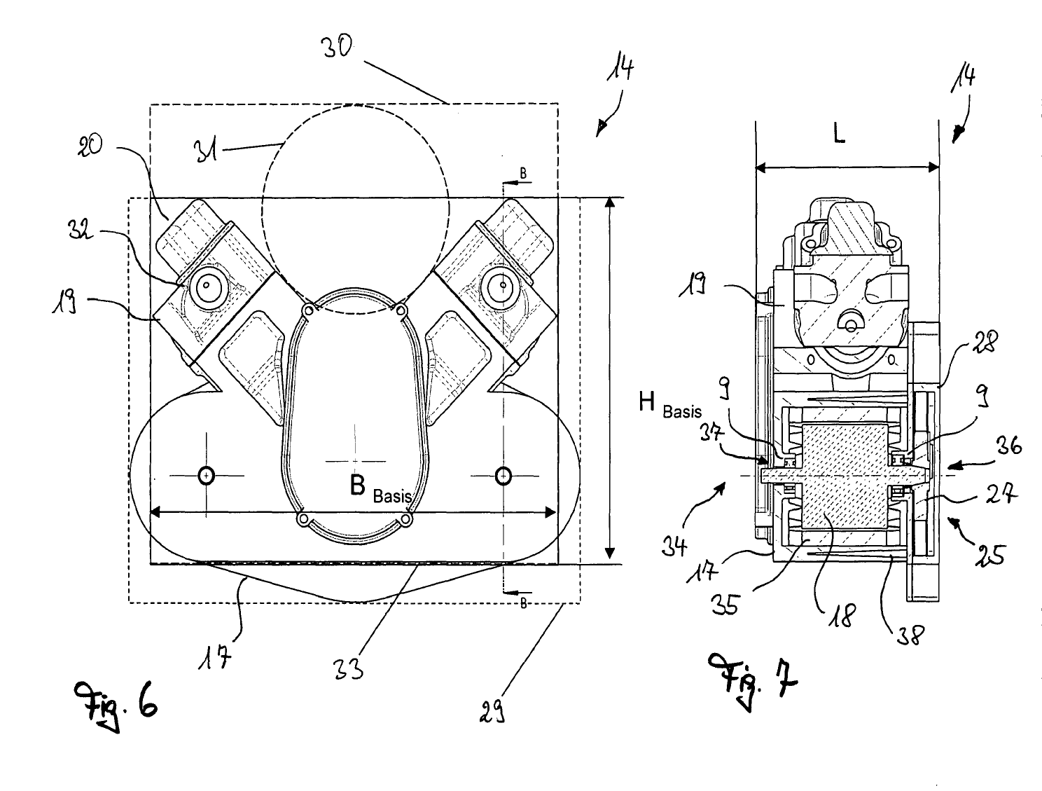

FIG. 7 shows a cross-sectional view along the section plane B-B from FIG. 6 for the V-motor with two generators. It is shown that, despite the fact that one or two generators are arranged, a length L of the energy conversion system 14 is not substantially longer than that without a generator. This view further shows, on one hand, the timing assembly 34 with which the respective camshaft in the cylinder head is driven by the crankshaft. On the other hand, the gear train 25 along with the casing cover is arranged opposite the control assembly 34, at the other end of the energy conversion system 14. The length L in this case includes the respective casing covers as the final dimension. The rotor 18 is therefore not larger overall than the cylinder head 19 that is placed on the crankcase 17. The stator coil package 35 of the generator is arranged inside the crankcase 17. In addition, a rotor bearing 39 is located at each end of the rotor shaft. Whereas a mount for the second gear 27 of the gear train 25 is arranged at a first shaft end 36, a mount for slip rings of an exciter coil for the roller 18 is arranged at the opposite, second shaft end 37. For holding the second gear, in particular if implemented as a spur gear, the first shaft end 36 preferably has a conical shape onto which the second gear 27 can be pushed and fixed. However, a different fitting shape that ultimately ensures the transmission of force and torque between the rotor shaft and the spur gear can also be provided. The two roller bearings are arranged such that one of the two bearings is seated in one of the casing covers and the other bearing in the crankcase. Preferably, the bearing on the timing assembly end is arranged in the crankcase 17, as shown, while the bearing on the gear train end is provided in the corresponding intermediate plate between the crankcase 17 and the casing cover 28. This allows, for example, an encapsulation of the rotor and stator and in particular the possibility that the generator formed thereof can be constructed dry or wet. For example, cooling of the generator may be provided by means of a water jacket 38. The water jacket preferably runs along the entire periphery of the stator. Thereby heat can be dissipated directly at the stator. The rotor 18, on the other hand, can be cooled by convective air cooling, for example. Alternatively and optionally additionally, however, oil cooling of the rotor by spraying with motor oil can be provided. The arrangement of the bearing in the crankcase 17 makes it possible for the slip rings to be run in a sealed state, especially if the rotor is oil-cooled.

If a single generator is used, it preferably has a diameter between 150 mm and 200 mm. A length is preferably up to 150 mm, according to one refinement. Thus its length L preferably remains within the maximum engine length. If two generators are used, it is provided that a stator package diameter is in the range between 100 mm and 160 mm, for example. The overall length of a rotor/stator package is preferably up to 150 mm. Thus, this length can likewise be arranged inside the total engine length L.

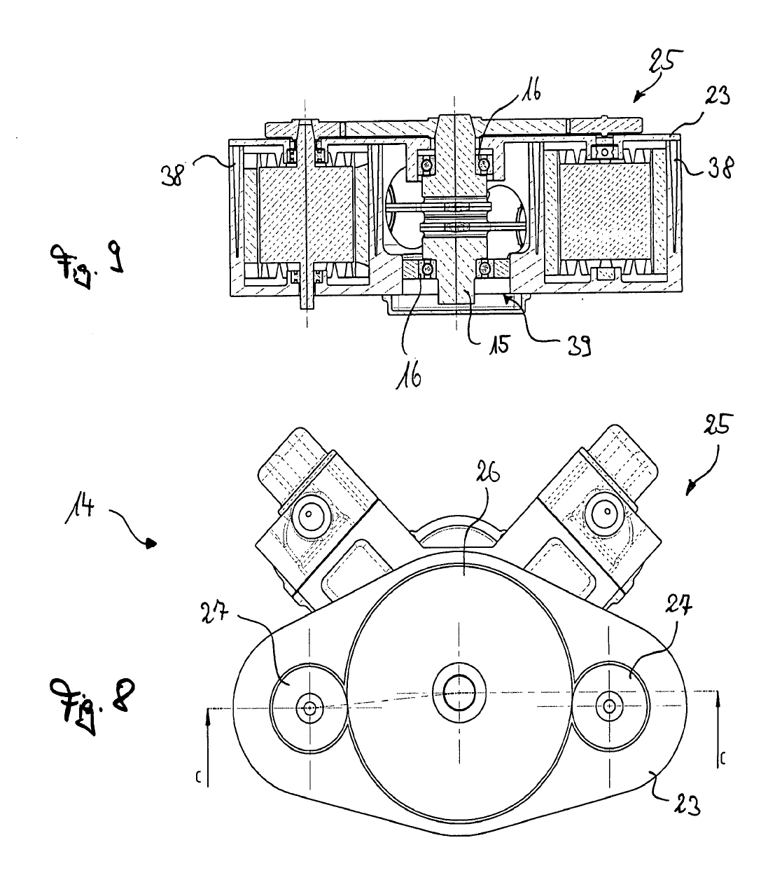

FIG. 8 shows a plan view of the energy system 14 on the gear train. The gear train with the first gear 26 and the two second gears 27 are preferably coupled together backlash-free via a gear connection. As shown, spur gears with inclined teeth are preferably used. They are only indicated schematically here. The spur gears are lubricated by means of the oil for the energy conversion system 14, for example. The covering of the gear train 25 with the casing cover, not shown here, on the one hand, and the intermediate plate 23 on the other, ensures that the oil used for lubrication cannot escape from the energy conversion system 14. Backlash-free spur gears can be found, for example, in WO 2005/090830 A1 and AT 004 880 U1. For a chain or belt drive, a backlash-free transmission is made possible in the manner found in FR 2805327 A as a backlash-free force transmission. In particular, the interaction of the force transmission from the crankshaft to the balancing shafts, in this case the rotor shafts, and thus to the second gears 27 is made possible because a flank backlash is kept as low as possible, in particular reduced to zero. This is enabled particularly by using the above-mentioned backlash-free spur gears or chain/belt drives, the contents of which patents are incorporated in full herein by reference.

Another possibility for suppressing the flank backlash of meshing gears is by a pairwise arrangement of tensioned gears with opposite angles of inclination. Such V-gearing has the advantage of not generating any axial forces on the generator or crankshaft bearings. For a gear train of a rotational connection, it is preferable to use gears made of a material with the same coefficient of expansion as the crankcase. This prevents an increase of backlash due to heating of the engine. The energy conversion system 14 seen in FIG. 8 need not be implemented only with a rotational connection comprising spur gears. Instead, it is also possible to use toothed belt runs, which connect the crankshaft play-free to the oppositely rotating rotor shafts. In particular, two generators can be arranged on the energy conversion system 14 in such a manner that a pair of forces is formed that lead to a relief of tension on the crankshaft.

Providing a clutch, on the first wheel 26 for example, or providing a shiftable clutch on the camshaft with an extra gear is also possible. This clutch is particularly advantageous if there is a manual starting process of the energy conversion system 14, for example by means of a rope drive, a kick-starter or a comparable starting device in contrast to an electrical starter. In particular, a decoupling of a compensation mass can be achieved in this manner, whereby vibrations of the energy conversion system 14 can be additionally reduced.

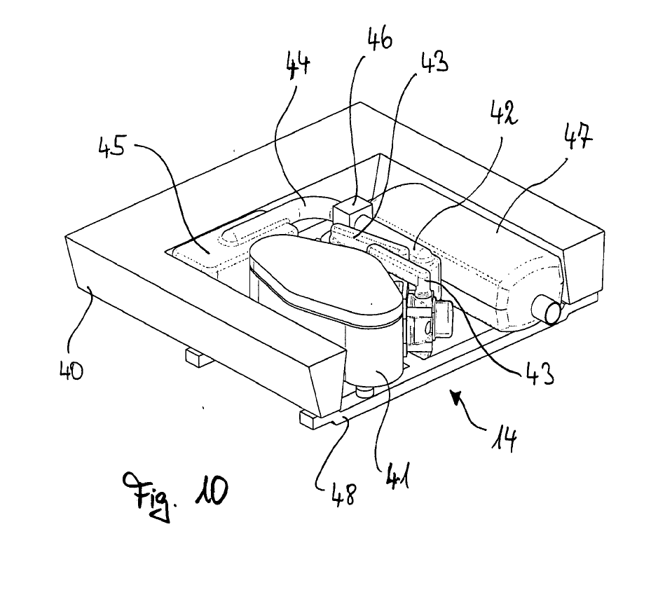

FIG. 9 shows a view along a section plane C-C from FIG. 8. It shows the position of the crankshaft, its rolling contact bearing 16 at each end as well as the cooling by a water jacket 38, which can cool not only the stators but also the crank space as such at the same time. This sectional view further clarifies that, for example, the rolling contact bearing 16 of the crankshaft 15 can likewise be arranged in the intermediate plate 23, while the side facing the gear train 25 has a cutout 39 that enables assembly of the crankshaft bearing as well as the crankshaft and the connecting rod in the energy conversion system 14.

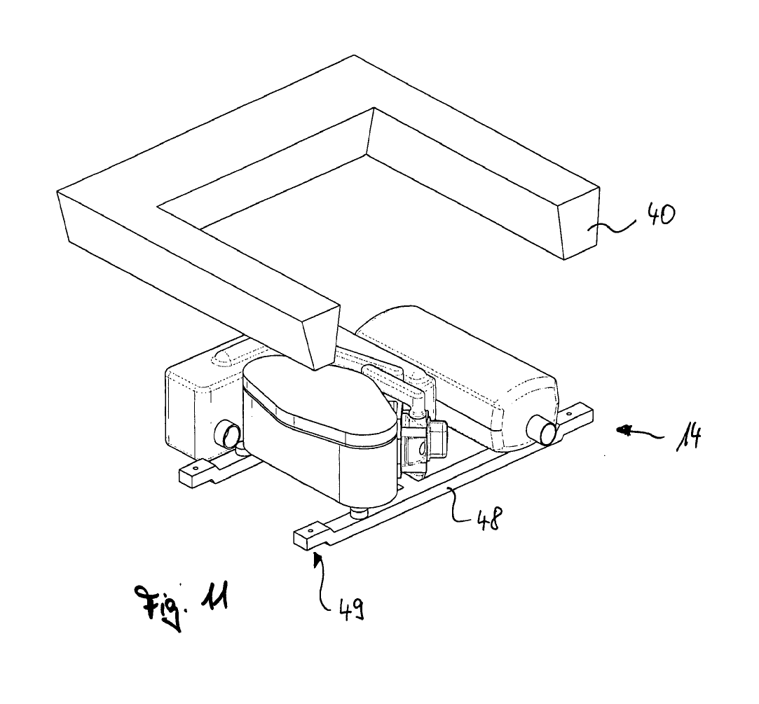

FIG. 10 shows an example configuration of a possibility for arranging an energy conversion system 14. Thus a cutout of a motor vehicle, in particular, body beams 40 of a vertical rear end, is shown for the sake of example. The energy conversion system 14 can be seated inside the U-shaped body beams 40, more particularly in such a manner that it does not project above the body beams at all or only unsubstantially. The energy conversion system 14 preferably comprises a V-engine with two generators and roll moment compensation as in the preceding figures. An intake bridge 42, which allows a subdivision of the supplied air to the two cylinders via intake air lines 43 in its function as an air distributor box, is coupled to this internal combustion engine 41. The intake bridge 42 is in turn connected to an intake tract 44 with an air filter box 45. The air filter box 45 allows separation of dust particles or other particles or solid bodies that would otherwise be supplied to the energy conversion system 14 from the environment. A throttle valve 46 is arranged in the intake tract 44, for example. The intake air supply can be regulated by adjusting the valve based on the load for example. The energy conversion system 14 further comprises an exhaust system 47 with a muffler. A compact arrangement of the energy conversion system 14 is thus enabled by situating it inside the U-shaped body frame. The energy conversion system 14 is preferably arranged on a frame 48. The frame 48 allows preassembly of individual components of the energy conversion system 14 before it is placed in the vehicle. In particular, the frame 48 also allows the provision of damping elements. A decoupling between components of the energy conversion system 14 and the frame, and between the frame 48 and the body beams 40, can be achieved by means of the damping elements. A transmission of vibrations is suppressed in this manner, so that on one hand, a part of the vibrations from the body itself is at least not transmitted to the energy conversion system 14 and on the other hand, any vibrations of the energy conversion system 14 are not transmitted to the vehicle. As shown, the design of the energy conversion system 14 also allows an arrangement of the V-engine in horizontal form. In contrast to a vertical arrangement, the horizontal arrangement allows underfloor installation, not only in a motor vehicle but also in other vehicles or equipment.

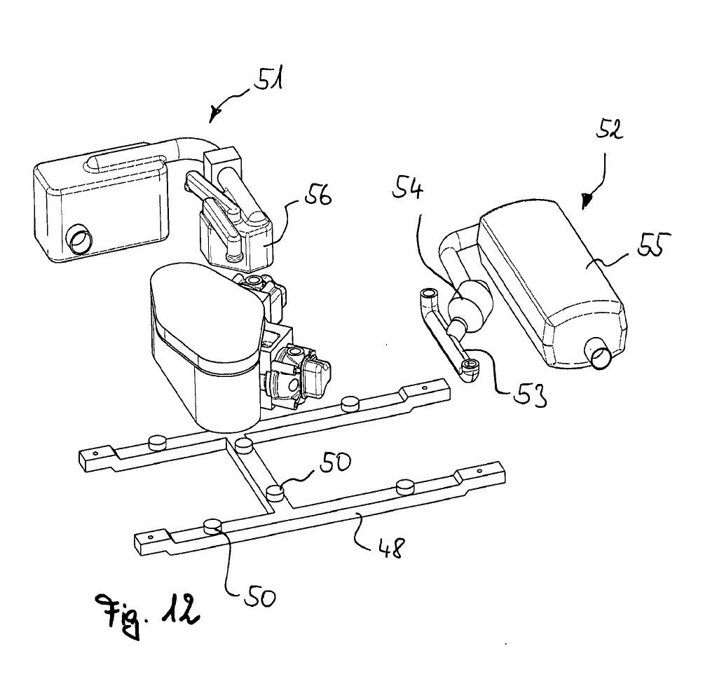

FIG. 11 shows the arrangement seen in FIG. 10 in a different representation. The frame with the energy-conversion system 14 is detached here from the body spaces 40. It can be seen that the frame 48 comprises mounting and fastening elements 49 that are matched to the body beams 40. A bolted connection between the body beams 40 and the frame 48 is preferred. This view further shows how an underfloor installation is made possible. If the vehicle is driven onto a pit or jacked up, the preinstalled energy conversion system 14 on the frame 48 can be arranged underneath the vehicle, lifted and then fixed to the body beams 40, assuming the appropriate amount of space. An arrangement of a radiator, a fuel tank and an engine control unit for the energy conversion system 14 separately from the frame 48 and the energy conversion system 14 thereon is preferably provided. A connection to the radiator, the fuel tank and/or the engine control unit can be made via appropriate connectors or plug connectors. Another configuration provides that the radiator, the fuel tank and/or the engine control unit are arranged on a frame of their own, which can likewise be arranged in the underfloor area of a vehicle, for example. It is also possible for the energy conversion system 14 to use a fuel tank with which an additional internal combustion machine of the vehicle is operated. The same applies to the radiator or the engine control unit. Another configuration provides that a radiator, a fuel tank and an engine control unit are also arranged on the frame 48. It is advantageous in this case that only one rather small electrical plug connection is necessary and the energy conversion system 14 functions as an autonomous power generation unit.

FIG. 12 shows the individual components of the energy conversion system 14 from FIG. 10 in an exploded view. The frame 48 comprises, for example, a first and a second longitudinal beam that are connected to one another via at least one cross member. The longitudinal beams are each bolted to the body beams. Elastic mounts 50 can be arranged on the longitudinal and cross beams. These are preferably rubber bumpers on which the engine, but also an exhaust system, can be supported. Preferably, the engine and the exhaust system mounting remains relatively stiff, as viewed in a vertical axis. This is enabled if a V-engine, more particularly a 2-cylinder V-engine, is used, in which only very slight excitations occur other than minimum tilting moments due to connecting rod offsets. In contrast to the rigidity in the vertical axis, the mounting is very soft in relation to the horizontal plane. This makes it possible in particular for vibration due to mass forces transverse to the crankshaft to be decoupled.

The exploded view of FIG. 12 also shows that the individual components can be preassembled as well. Thus the V-engine including cylinder heads is preassembled, for example. The air system 51 can be placed thereon and fixed to the frame or the V-engine. According to one configuration, the exhaust system 52 is previously arranged on the frame 48. The exhaust system 52 according to this configuration comprises a downstream catalytic converter 54 in addition to an exhaust manifold 53 with a first and a second support. The exhaust is routed from the catalytic converter to the muffler 55. From there it can preferably flow into the environment. An exhaust gas turbine, for example, can be arranged in the exhaust system 52. Preferably, however, a mechanical charger can also be provided in the air system 51. The arrangement of the exhaust system 52 as the first component mounted on the frame 48 makes it possible for the supports of the exhaust manifold 53 to then be fixed to the cylinder heads of the V-engine before it is in turn fixedly positioned and bolted to the frame 48. The low arrangement of the exhaust manifold saves space and in particular allows a crossflow scavenging in the cylinder head. This can reduce heating of the surrounding components. Crossflow scavenging in the cylinder head is also possible with a different arrangement of the air supply and exhaust removal on the cylinder head, however. The exhaust gas tract between the engine and the muffler preferably comprises at least one decoupling member. It is preferably arranged between the manifold and the catalytic converter, or downstream of the latter. Vibrations and thermal stresses can be reduced in this manner. In the configuration of a compact range extender or generator for a motor vehicle introduced here, the volume of the muffler is preferably between 10 and 20 L.

The air system 51 with the air distributor box 56, for example, has tuned suction pipe lengths, especially in the air distribution box 56. These are used especially for optimum space utilization in the area created by the V-arrangement of the cylinders. The throttle valve housing is used simultaneously as a connecting member to the air filter box, according to one refinement. The air filter box can be accommodated on the frame between the engine and the exhaust system, for example, or separately in an unused space in the body. An air filter can be replaced without detaching the frame from the vehicle. An appropriate access to the air filter box is created for this purpose. An oil level can also preferably be checked without the frame having to be separated from the vehicle. An oil check using a dipstick can be provided for this purpose. The oil and filter are preferably changed with the vehicle jacked up. By means of a maintenance opening in a bottom plate, an air filter can then be changed from above, for example. An oil check by means of a dipstick can also be carried out through this opening. There also exists the possibility of recording the oil level with an appropriate sensor and transmitting it onward.

The configuration provided for the sake of example in FIG. 10 for a compact range extender, having a V-engine and an exhaust system, installed inside body beams in the vehicle rear and together on a frame, allows operation that is not perceptible by the user of the vehicle, in addition to its considerable compactness and simultaneous roll moment compensation of the generators. A horizontal arrangement of the engine, in particular, allows an optimal NVH behavior, especially if V2 engines are used.

FIG. 13 shows another configuration of how a first shaft and a second shaft of an energy conversion system can be coupled to one another. In a representation on the left, FIG. 13 shows two meshing gearwheels, each positioned on the shaft. Such a configuration requires an axial securing mechanism, so that active forces do not lead to a displacement or damage to components. The representation on the right in FIG. 1 shows a cutout of a proposed energy conversion system that is not shown in detail in this figure. A transmission 100 comprising a first shaft 102 in the form of an output shaft and a second shaft 103 that are both coupled together is shown. The first shaft 102 comprises a first gearwheel 104. The second shaft 103 comprises a second gearwheel 105. The first gearwheel 104 and the second gearwheel 105 mesh with one another and form a common attuned gearing 106. In addition, the first gearwheel 104 and the second gearwheel 105 have a shared axial guide 107 for one another. The axial guide seven [sic; 107] has a first guide 107.1 and a second guide 107.2 for this purpose. The first guide 107.1 and the second guide 107.2 have the shared gearing 106 in their center. It is preferred if a gap is provided. An oil pocket can be provided by means of the gap 108, as is seen even more clearly in the subsequent figure. Additionally, an inclined surface has the effect that a geometric adaptation is possible, by means of which the problem of a surface pressure when an axial force is active can be taken into account, for example. It is preferred if the first and the second guides each have an overlap area 109 for the surfaces that are allotted to the first and the second gearwheel 104, 105 for forming the axial guide 107. The contact point or contact area of the respective first and second guides 107.1 and 107.2 is located in this overlap area 109. This area is indicated by the radii r1 and r2.

One configuration provides that a point contact is specified for those places at which a contact between the guides of the gearwheels occurs. Another boundary condition is preferably that a velocity vector of the two guides or gearwheels should be identical. One approach provides that a selection of the gearwheels be carried out as follows:

A first gearwheel with a number of teeth z1 and a second gearwheel with a number of teeth z2 are to mesh with one another. The gearwheel dimensions have been determined in advance, for example, based on the torque to be transmitted, the forces occurring in the meshing teeth areas, particularly on the teeth flanks, but also at the root of the teeth, and also based on the installation space available. The axial guide now comprises the contact area, which can be assumed to be contact points in an ideal case. For example, if a guide surface on the second gearwheel is chamfered but the guide surface of the first gearwheel is left with a sharp edge, then nearly a point contact results. The contact points of the left and the right guides then follow, starting from the respective shaft axis as a radius, from the following analysis:

r1=a/(1+z2/z1)

and

r2=a−r1

with

a: distance between the axes of the first and second shafts

z1: number of teeth of the first gearwheel 1

z2: number of teeth of the second gearwheel 2

r1: radius starting from the first shaft, on which the first gearwheel is seated

r2: radius starting from the second shaft, on which the second gearwheel is seated

The actual gearing is then on the two gearwheels between the first guide and the second guide. If the two radii r1 and r2 are designed according to the formulas, then the points of contact of the first and second guide have identical velocities. There is then no relative velocity between geometries of the two guides, which is why there is no sliding friction.

An optimization can additionally provide the creation of a chamfer. It is provided, in particular, between an outer side of a gearwheel and a guide surface of the axial guide. A magnitude of the contact surface can be adjusted by creating a guide surface at a contact circle of the first and second guides. In particular, a conflict of goals between an excessively high surface pressure and an increase of friction losses can be resolved, for example, by optimization with specifications of maximum limit values to be maintained.

An optimization can additionally take into account the dynamic forces that occur. For example, a jolting behavior can appear in the case of transient behavior of the energy generator, which can then be compensated by the axial guide. Other axial forces, especially impulse-like forces, of the type that can occur, for instance with slant-toothed gearwheels, can be compensated by the axial guide, so that a transmission onto the shafts can be avoided.

In addition, a lubrication can also be taken into account as part of the design. The lubrication can be supported by the selection of the lubricant, by the supplying of the lubricant and the resulting lubricant film thickness, as well as by the geometric formation of surfaces. For example, a geometry selection that preferentially supports the creation of a lubricant film in the area in which surfaces slide upon one another can contribute to at least reducing friction, if not indeed rendering it negligible, by sliding friction of a lubricant film, for example. For example, a sump can be provided in which lubricant collects and thus can form a particularly thick lubricant film. The sump is arranged, for example, in the area where the surfaces meet one another. Another configuration provides that, especially underneath an edge or other geometry of one surface, a wedge-shaped gap is arranged so that an oil pocket is formed for lubricating or providing a supporting oil film. This supporting oil film can build up in an overlap zone of the axial guide surfaces. Due to the rotation of the surfaces, the oil can be transported in the direction of the supporting areas and can be compressed there between the surfaces that meet one another. In addition, draining away of the oil can at least be made more difficult, if not even prevented, by the geometric form, so that a desired carrying force can be adjusted by the formation of an appropriately supporting oil film by means of such a wedge shape.

In addition, within the scope of the present disclosure and particularly with respect to FIG. 13, the entire relevant contents of a not-yet published application by the present applicant that was submitted on Jun. 24, 2011 to the German Patent and Trademark Agency with the title “Axial Guide for Gearwheels” are incorporated herein by reference.

FIG. 14 shows a gearing configuration that can be advantageously used particularly for roll moment compensation if the noise generated with other gear units for the desired application becomes too high. It is proposed that a herringbone gearing as illustrated be used. This is a combination of right-hand and left-hand helical gearing. Axial forces are also canceled out when this configuration is used. As an alternative to herringbone gearing, there is also a possibility of providing curved teeth. This is an alternative, particularly to helical gearing, in which impulse-like axial forces can be introduced via the gear teeth into both shafts, the crankshaft and the balance shaft.

The individual configurations and features found in the foregoing figures and in the wording are not limited to the embodiment shown for the sake of example. Instead, one or more of these features from one or more of these figures can also be combined with other advantageous configurations. Thus the application of the proposed technology to energy conversion systems with cylinder volumes of one liter or less is particularly preferred. The application can be a main drive for a motor vehicle, e.g. a 0.7 L engine with three cylinders. The use can also be applied to industrial engines such as those for small excavators, hand-held tools or the like. In addition to small numbers of cylinders, turbocharging can also be provided, particularly mechanical turbocharging. The turbocharging can be in one or two stages. When the energy conversion system is used as a traction drive, then preferably rotational speeds between 800 and 1500 rpm are provided, with center bridges of up to 20, especially 25 bar. For example, the energy conversion system can be used with motor vehicles, but also with two-wheeled vehicles such as motorcycles or motor scooters. Use with other vehicles such as ships is also possible. For example, use as an outboard motor or as a fixedly installed motor is possible in order to drive a ship propeller. It is also possible to use the energy conversion system exclusively for generating power, e.g. on ships, boats or aircraft. Thus use as an auxiliary drive is possible. In particular, the energy conversion system can also be used as a stationary unit. It can also be operated at constant speed.

According to one configuration, the energy conversion system is implemented as a portable system. A portable system can have a weight less than 30 kg, for example. In this manner, it can be carried by a single person. For instance, it can be provided as a backpack system and thus brought to otherwise inaccessible places to allow provision of power there. Especially the use as a mobile energy generator such as an emergency power supply is made possible.

In addition to using one energy conversion system of this type, two or more such energy conversion systems can be used together, independently of one another or coupled to one another, arranged separately from one another as well as in a single vehicle or a building installation.

If a motorcycle engine is configured according to the proposed energy conversion system, for example, an alternator can be combined with a mass compensation gear unit as proposed, in order to eliminate first or second order mass forces.

When used as an APU in small vehicles, especially in small aircraft, it becomes possible to provide a replacement for systems that would otherwise be driven by the main power unit. The APU can also be used to start a main unit. It is also possible to use the energy conversion system in an unmanned aircraft, especially a drone, or in a helicopter. The same applies to a remote-controlled robot vehicle. In each of these cases, it can be used as a single unit and as an auxiliary unit. If employed as a power generation unit, the energy conversion system can be used, for example, in motor homes as well as in military vehicles or other vehicles such as transmitter vehicles, measurement vehicles, containers or other mobile units. It can also be used as a backpack generator. In particular, the energy conversion system can also be used everywhere that onboard power generation via the large main machine is not always desirable. The energy conversion system can also be used in underwater vehicles, particularly in submarines. Use of the energy conversion system within an enclosed housing makes it possible to adjust the noise behavior in such a manner that no disruption, and in particular no loud operating noises, are transmitted. Vibration of the unit is prevented by the compensating oppositely rotating shafts and the associated balance when starting and stopping the energy conversion system. Vibrations and interference generated thereby do not appear at all. This allows a frame in which the energy conversion system is arranged, for example, to be reconstructed differently, more particularly, less rigid with respect to its strength. Particularly according to one configuration, it can be provided that the energy conversion system is mounted solely on a frame, without the necessity of an enclosure as such in order to impart sufficient rigidity to the frame.

Another configuration provides, for example, that the energy conversion system is arranged as a power generator for a vehicle in its wheel well. The energy conversion system can also be combined with an electric vehicle. In particular, the energy conversion system is arranged interchangeably. The use of the energy conversion system as a traction drive also allows a variety of design possibilities. Thus the crankcase can be used as a component of the frame for a two-wheeled vehicle or a three-wheeled vehicle, for example. Due to the compensation of the products of moments of inertia and respective associated rotational speed ratios, no tilting moments appear even in the widest variety of rotational speed ranges and this thereby facilitates calm driving behavior for such a two-wheeled vehicle.

The components coupled to one another via the rotational connection can all be identical, if energy generation is sought. For example, identical generators can be, or be capable of being, coupled to one another. There is also the possibility that similar types of components coupled or capable of being coupled by the rotational connection can be constructed differently from one another. For example, different models of generators can be, or be capable of being, coupled to one another. Thereby different types of components can each be assigned to a different task, or the components can be designed specifically for the relevant task. In the case of several generators, for example, synchronous as well as asynchronous machines and also direct-current machines can be used. They can also differ from one another in construction and in their electrical output.

Another configuration provides, for example, that one or more components within the rotational connection can be switched on and off, i.e. coupled and decoupled. For instance, a different number of components can be coupled to one another during a starting process than during an operation of the energy conversion system. One configuration provides, for example that only one generator, but at least not all generators of the energy conversion system, can be coupled to one another by the rotational connection during a startup of the energy conversion system. Additional units can be added when operation is ongoing. But others can also be decoupled. It is preferred if individual components can be controlled individually, for example, if those components that are to be coupled and decoupled can be individually controlled. One example provides, for instance, that two or more generators that are coupled via the rotational connection can be jointly or individually controlled. The control can relate to coupling and decoupling, but also to other functionalities of the components.

One refinement provides that only one electrical machine is operated as a generator at the startup of the system. The remaining electrical machines, in particular generators, if any, remain mechanically coupled to the one generator that is starting. In this manner, the entire system remains balanced. The starting generator is preferably configured for this purpose as a 4-quadrant machine.

The switching on or off can also take into account a freewheel that may comprise a component in one rotational direction. For example, one or more freewheels of components can be provided in the rotational connection. They may be effective in only one direction, and may be permanently present and/or can be switched on and off.

1. An energy conversion system comprising:
an internal combustion machine and a generator driven by the internal combustion machine, and with a rotational connection that couples a first shaft of the internal combustion machine rotating in a first direction to at least one second shaft of the energy conversion system, wherein the at least one second shaft rotates in an opposite direction to that of the first shaft and the first shaft is arranged parallel to the second shaft, wherein a plurality of products of moments of inertia and respective associated rotational speed ratios of individual rotating components rotationally coupled to one another by means of the rotational connection at least substantially cancel one another out.

2. The energy conversion system according to claim 1, characterized in that the internal combustion machine provides a torque by means of reciprocating or rotating pistons.

3. The energy conversion system according to claim 1, characterized in that a rotor shaft of the generator rotates in the opposite direction to that of the first shaft.

4. The energy conversion system according to claim 1, characterized in that the second shaft is an input shaft of a component from a group comprising a mechanical loader, an air-conditioner compressor, a vacuum pump, a power steering pump and a coolant pump.

5. The energy conversion system according to claim 1, comprising an engine housing, with a valve train and a cylinder head, a crankshaft in a crankcase as the first shaft, and a balance shaft unit with at least one balance shaft as the second shaft, wherein a sum of the plurality of products of moments of inertia and the respective associated rotational speed ratios of individual components coupled to one another, comprising at least the crankshaft and the balance shaft on the motor housing of the internal combustion engine, is at least approximately compensated.

6. The energy conversion system according to claim 1, characterized in that the first shaft is arranged in a crankcase and the second shaft in a housing separable from the crankcase.

7. The energy conversion system according to claim 1, characterized in that the first shaft is arranged vertically in such a manner that an axis of the first shaft runs parallel to an earth acceleration vector.

8. The energy conversion system according to claim 1, characterized in that it the energy conversion system is provided as an additional energy converter to a main energy converter.

9. The energy conversion system according to claim 1, characterized in that the internal combustion engine is operated according to the Atkinson process to minimize an exhaust pressure surge.

10. The energy conversion system according to claim 1, characterized in that the internal combustion engine comprises a turbocharger and is operated according to the Miller cycle.

11. The energy conversion system according to claim 1, characterized in that the rotational connection comprises a planetary gear unit.

12. The energy conversion system according to claim 1, characterized in that the rotational connection is play-free.

13. The energy conversion system according to claim 5, characterized in that the rotational connection comprises a belt drive.

14. The energy conversion system according to claim 13, characterized in that the crankshaft comprises a connection to the balance shaft by means of a first belt and a second belt that are wrapped in opposite directions.

15. The energy conversion system according to claim 13, characterized in that one or more loads that are driven by the crankshaft or the balance shaft are coupled for force transmission by means of a belt drive.

16. The energy conversion system according to claim 13, characterized in that the belt drive comprises a belt having an inside and opposite outside that is profiled on the inside and on the outside.

17. The energy conversion system according to claim 1, characterized in that a non-integer transmission ratio is adjusted between the first and the second shaft.

18. The energy conversion system according to claim 1, characterized in that a transmission ratio between the first and second shaft is adjustable.

19. The energy conversion system according to claim 1, characterized in that it the energy conversion system is portable.

20. The energy conversion system according to claim 1, characterized in that the energy conversion system comprises two or more generators that are coupled to one another via the rotational connection.

21. The energy conversion system according to claim 21, characterized in that the two or more generators are different.

22. The energy conversion system according to claim 20, characterized in that the two or more generators can be controlled individually.

23. The energy conversion system according to claim 22, characterized in that not all generators, preferably only one generator, are coupled via the rotational connection at startup.

24. The energy conversion system according to claim 20, characterized in that only one generator is designed for starting the system.

25. The energy conversion system according to claim 1, characterized in that an axial guide is provided to mesh at least one gearwheel of the first shaft and at least one gearwheel of the second shaft with one another.
